(19) United States
(12) Patent Application Publication
(10) Pub. No.: US 2002/0006472 A1
(43) Pub. Date: Jan. 17, 2002

(54) Process for forming ovelay on sliding member

(76) Inventors: Kyoko Kazi, Nagoya (JP); Takuya Tanaka, Nagoya (JP); Nobutaka Hiramatsu, Nagoya (JP); Takayuki Shibayama, Nagoya (JP)

Correspondence Address: BROWDY AND NEIMARK, P.L.L.C., 624 NINTH STREET, NW, SUITE 300, WASHINGTON, DC, 20001-5303, US

(21) Appl. No.: 09/836,318

(22) Filed: Apr. 18, 2001

(30) Foreign Application Priority Data
May 2, 2000 (JP) 2000-133512

(51) Int. Cl. B05D 1/28; B05D 5/00; B05D 3/02

(52) U.S. Cl. 427/388.1; 427/429

(57) ABSTRACT

Liquid dispersion A containing a thermosetting resin and a solid lubricant is applied to the inner surface of half bearing 1 by pad printing and then cured by heating to form lubricating film layer 4 of the inner surface of half bearing 1, where liquid dispersion A is pressed onto the inner surface of half bearing 1 by pad 7, whereby the density is made higher to increase the bond strength and improve the wear resistance and the cavitation resistance.

### BACKGROUND OF THE INVENTION

The present invention relates to a process for forming a lubricating film layer on a sliding member directed to improvement of initial conformability, wear resistance, etc.

The surfaces of bearings for automobile engines have been so far resin-coated to improve the initial conformability, wear resistance, etc. One example of it is disclosed in JP-A-9-79262, where a liquid dispersion prepared by adding a solvent to a solid lubricant (molybdenum disulfide) and a thermosetting resin (polyimide resin), followed by mixing is air-sprayed onto the surfaces of bearings, followed by curing by heating to form a lubricating film layer thereon.

However, the air-spray coating method inevitably makes the working environment worse and since the liquid dispersion of a low viscosity must be prepared by increasing a proportion of the solvent, while decreasing proportions of the solid lubricant and the thermosetting resin, which finally become a lubricating film, resulting in poor retainability of the liquid dispersion on the sliding member. Furthermore, the solvent in the liquid dispersion sprayed on the bearings will evaporate off in the successive heating step, but since the proportion of the solvent has been large so far, number of voids formed in the lubricating film layer by evaporation of the solvent will be increased. As a result, the lubricating film layer becomes porous and will have a lower density, so that no satisfactory strength can be obtained, resulting in poor cavitation resistance and wear resistance. Still furthermore, the liquid dispersion sprayed on the bearings is cured in a sprayed state without processing, resulting in poor bond strength of the resulting lubricating film layer toward the bearing.

### SUMMARY OF THE INVENTION

The present invention has been made to solve the foregoing problems, and an object of the present invention is to provide a process for forming an overlayer on a sliding member, capable of making the working environment better, improving the retainability of the liquid dispersion on the sliding member, and forming a lubricating film layer of high density and distinguished strength, cavitation resistance and wear resistance, and also a high bond strength of the lubricating film layer toward the sliding member with less peeling.

The present invention provides a process for forming an overlayer on a sliding member, which comprises applying a liquid dispersion containing a thermosetting resin and a solid lubricant to the surface of a sliding member by pad printing, thereby forming a lubricating film layer on the surface of the sliding member.

According to the present process for forming an overlayer on a sliding member, a lubricating film layer is formed on the surface of a sliding member by pad printing and thus a proportion of a solvent in a liquid dispersion can be made smaller, whereas proportions of a solid lubricant and a thermosetting resin can be made larger, resulting in better retainability of the liquid dispersion on the sliding member. Furthermore, the smaller proportion of the solvent can decrease a proportion of voids formed in the lubricating film layer by evaporation of the solvent, resulting in formation of a high density lubricating film layer. That is, a lubricating film layer with a good strength, distinguished wear resistance and cavitation resistance can be formed thereby. Furthermore, the liquid dispersion is pressed onto the surface of the sliding member by a pad and thus the bond strength of the lubricating film layer toward the sliding member can be made higher.

### BRIEF DESCRIPTION OF THE DRAWINGS

FIGS. 1A-1G shows a series of application step views by pad printing according to a first embodiment of the present invention.

FIGS. 2A and 2B show modes of transfer of a liquid dispersion to a half bearing by pad.

FIG. 3 is a perspective view of a pad.

FIG. 4 is a perspective view of a half bearing.

FIG. 5 is a cross-sectional view of a half bearing.

FIGS. 6A-6C show side views of half bearing and pad working to carry out application of a liquid dispersion by pad to half bearing in a plurality of runs as a divided manner according to a second embodiment of the present invention.

FIG. 7 a view of a pad similar to FIG. 3 according to a third embodiment of the present invention.

In the drawings, reference numeral 1 shows a half bearing (sliding member), 4 a lubricating film layer, 6 an intaglio, and 7 and 11 pads.

### DETAILED DESCRIPTION OF THE INVENTION

In the present invention, application of a liquid dispersion to the surface of a sliding member by a pad can be carried out in a plurality of runs in a divided manner, whereby a liquid dispersion can be well applied to the surface of a sliding member even in a complicated shape with a better bond strength of the resulting overlayer to the surface of the sliding member.

Furthermore, the present process can be applied to a half bearing. In that case, a pad is made from an elastically deformable material so as to make the pressing part of the pad against the inner surface of the half bearing have an arc-shaped surface or a spherical surface having a smaller outer diameter than the inner diameter of the half bearing, thereby applying the liquid dispersion to the surface of the half bearing while squeezing air from between the half bearing and the pad in contact.

### DESCRIPTION OF PREFERRED EMBODIMENTS

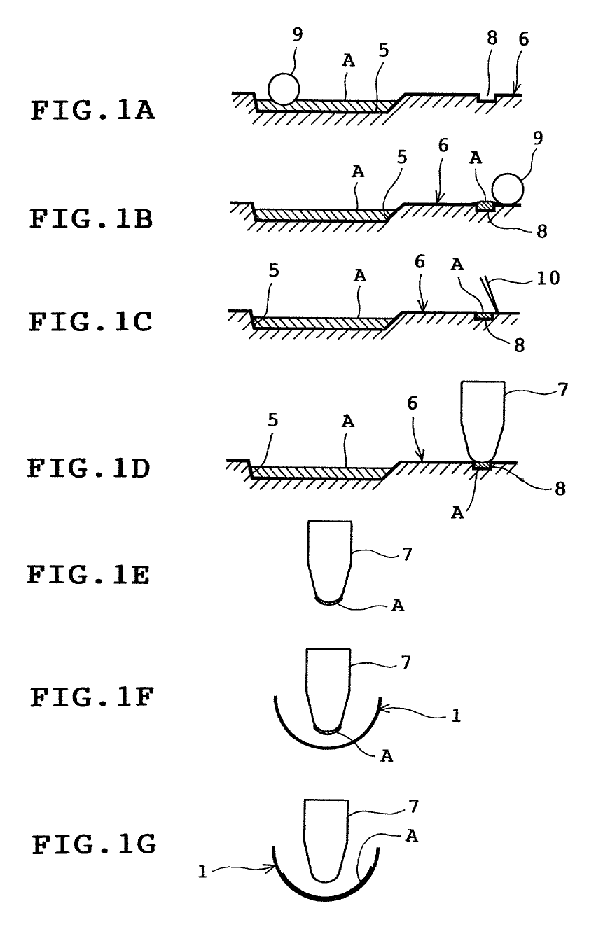

The present invention will be explained below according to a first embodiment as applied to bearings for automobile engines, referring to FIGS. 1A-1G, FIGS. 2A-2B, FIG. 3, FIG. 4 and FIG. 5.

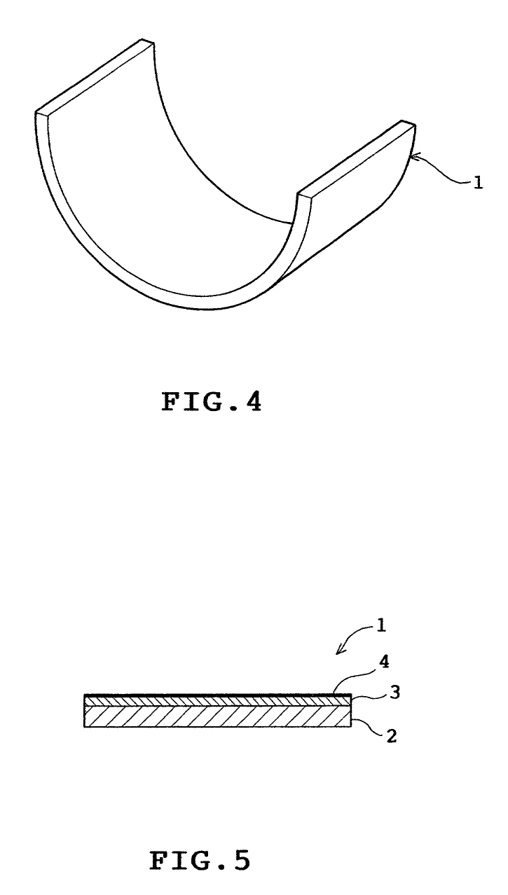

Bearing as a sliding member for use in automobile engines is composed of an assembly of a pair of half bearings 1, one of which is shown in FIG. 4. Half bearing 1 comprises back metal 2 made of a steel plate, aluminum or copper-based bearing alloy layer 3 laid on back metal 2 and lubricating film layer 4 as an overlay laid on the surface of bearing alloy layer 3, as shown in FIG. 5.

Said lubricating film layer 4 is formed by pad printing. Pad printing is a procedure of transferring an ink retained on an intaglio to a soft pad, and pressing the ink-transferred pad to a target substrate, thereby retransferring the ink to the target substrate. To form lubricating film layer 4 by pad printing, intaglio 6 with liquid storage recess 5 and pad 7 are at first made ready for use, as shown in FIG. 1A, where intaglio 6 is provided with roll 9 for transporting a liquid dispersion stored in liquid storage recess 5 to recess 8 for forming a transfer pattern and with doctor 10 for scraping the transported excess liquid dispersion in-recess 8.

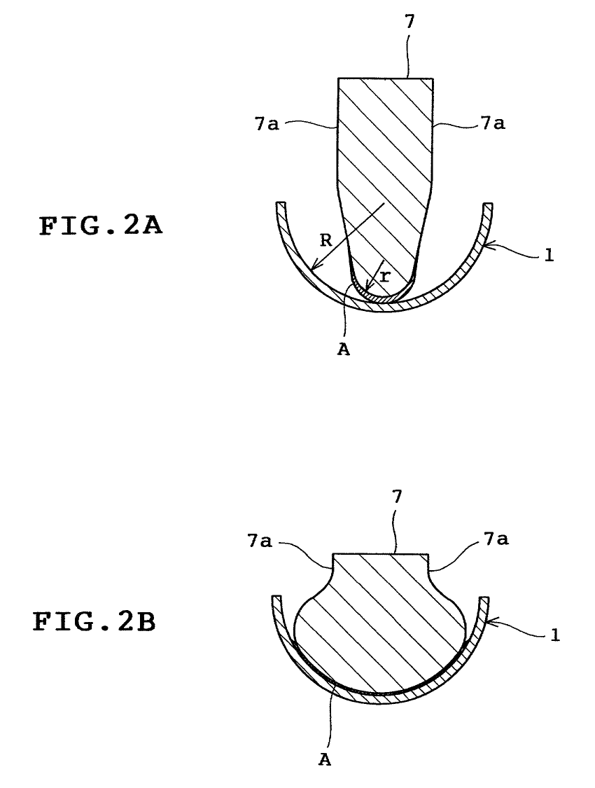

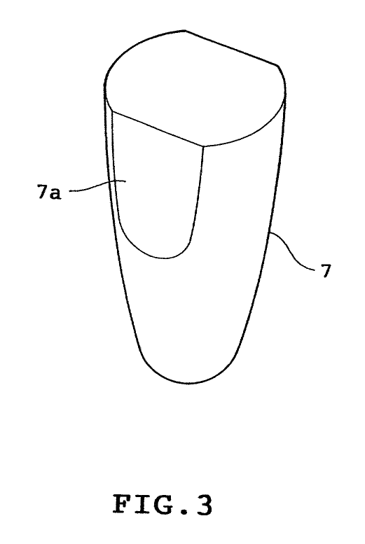

Pad 7 is made from an elastically deformable material such as silicone rubber, etc., and its vertical cross-section is in a parabolic shape as the whole and substantially in a bowl shape at the lower half part as shown in FIG. 3. Two sides facing each other of the upper part of pad 7 are cut away to form vertical flat surfaces 7a. The spherical surface of the bowl-shaped part at the lower half part of pad 7 has a smaller radius r than radius R of the inner surface of half bearing 1, as shown in FIG. 2A.

Liquid dispersion A to be stored in liquid storage recess 5 of intaglio 6 is a mixture composed of a solid lubricant, a wear-resisting material, if required, a thermosetting resin as a binder and a solvent. The solid lubricant includes, for example, molybdenum disulfide, graphite, etc., the wear-resisting material includes, for example, copper-based powder, etc., and the thermosetting resin includes, for example, polyamideimide, epoxy resin, etc.

Procedure for forming lubricating film layer 4 on the inner surface acting as the bearing surface of half bearing 1 will be explained below. At first, roll 9 is dipped in liquid dispersion A stored in liquid storage recess 5 of intaglio 6 to attach liquid dispersion A to roll 9 as shown in FIG. 1A. Then, roll 9 is rotated over intaglio 6 to transport attached liquid dispersion A into recess 8, as shown in FIG. 1B, and transported excess liquid dispersion A is scraped by doctor 10 to return the excess to liquid storage recess 5, as shown in FIG. 1C.

Then, liquid dispersion A retained in recess 8 is transferred onto pad 7, as shown in FIGS. 1D and 1E. Then, transferred liquid dispersion A is retransferred onto half bearing 1 by pressing pad 7 to the inner surface of half bearing 1, as shown in FIG. 1F and FIG. 1G. Since radius r of pad 7 is smaller than radius R of half bearing 1, the apex of pad 7 at the center of the lower half part is at first brought into contact with the surface of half bearing 1 as shown in FIG. 2A, and then the contact is extended from the apex to the peripheral side by elastic deformation as shown in FIG. 2B, and thus liquid dispersion A can be transferred to a broader range of the inner surface of half bearing 1, while squeezing air from between pad 7 and the inner surface of half bearing 1.

Ultimately, pad 7 is elastically deformed while following the circumferential profile of inner surface of half bearing 1 by the elastic deformation, and since the sides having vertical flat surfaces 7a of pad 7 are more elastically deformable, pad 7 can much better elastically deformed, while following the circumferential profile of inner surface of half bearing 1 by setting the sides having vertical flat surfaces 7a to accord with the circumferential direction of half bearing 1. Since pad 7 has a spherical surface at the lower half part and since the apex of pad 7 at the center of the lower half part lastly leaves half bearing 1, a trace of pad 7 is hardly left on the applied liquid dispersion on the inner surface of half bearing 1 at the center. In this manner, liquid dispersion A can be well transferred onto the inner surface of half bearing 1 by pad 7. Then, half bearing 1 is heated at 190° C. for 30 minutes, whereby the solvent is evaporated from liquid dispersion A and the thermosetting resin is cured, thereby converting liquid dispersion A to lubricating film layer 4.

In this embodiment, liquid dispersion A is applied to the inner surface of half bearing 1 by pad printing, and thus concentrations of a wear-resisting material, a solid lubricant and a thermosetting resin can be made higher, as compared with the case of spray coating, whereby the retainability of the liquid dispersion on a sliding member can be improved and evaporation of a solvent can be made less in the heating/curing step, thereby reducing void formation in lubricating film layer 4, making lubricating film layer 4 have a higher density and improving the cavitation resistance. Furthermore, since liquid dispersion A is pressed onto the inner surface of half bearing 1 by pad 7, the bond strength of lubricating film layer 4 toward the inner surface of half bearing 1 can be increased and the density can be increased, thereby improving the wear resistance.

Furthermore, lubricating film layer 4 can be provided at least on the center region in the circumferential direction, which is most heavily susceptible to a shaft load. That is, lubricating film layer 4 can be formed in that region by carrying out one run of the transfer of liquid dispersion A from pad 7 to half bearing 1. This means that the liquid dispersion can be applied to half bearing 1 within a very short time.

The following Table 1 shows relative densities of lubricating film layers and results of cavitation-erosion test and wearing test of test pieces of the present embodiment with a lubricating film layer formed thereon by pad printing and conventional test pieces with a lubricating film layer formed thereon by spray coating, where “\mathring{a} density ratio)” means (\mathring{a} a ratio of) a measured density of lubricating film layer relative to its true density, PAI stands for polyamideimide, EP for epoxy resin, and Cu for an additive for further improving the wear resistance. Table 2 shows conditions for cavitation-erosion test and Table 3 shows conditions for wearing test.

TABLE 1
Lubricating film layer

| | | | | | | | | Cavita- | |
|---|---|---|---|---|---|---|---|---|---|
| | | | | | | | | tion- | |
| | | | Mix components in | | | | (\mathring{a} | erosion | Amount |
| | | | liquid dispersion | | | | Density | (×10⁻³ | of wear |
| | | | PAI | EP | MoS₂ | Cu | ratio) | cm³) | (μm) |
| Con- | Spray | \mathring{1} | 40 | | 60 | | 73 | 2.0 | 18 |
| ven- | coat- | \mathring{2} | 35 | | 60 | 5 | 73 | 1.5 | 14 |
| tional | ing | \mathring{3} | 60 | | 40 | | 74 | 1.2 | 3 |
| test | | \mathring{4} | | 35 | 60 | 5 | 75 | 1.7 | 15 |
| pieces | | \mathring{5} | | 60 | 40 | | 73 | 1.1 | 2 |
| Test | Pad | \mathring{1} | 40 | | 60 | | 85 | 1.0 | 12 |
| pieces | print- | \mathring{2} | 35 | | 60 | 5 | 87 | 0.7 | 10 |
| of the | ing | \mathring{3} | 60 | | 40 | | 89 | 0.4 | 1 |
| embodi- | | \mathring{4} | | 35 | 60 | 5 | 89 | 0.8 | 9 |
| ment | | \mathring{5} | | 60 | 40 | | 90 | 0.4 | 1 |

TABLE 2
Conditions for cavitation-erosion test

| Item | Conditions | |
|---|---|---|
| Test piece | 60 in diameter × | Unit |
| dimension | 25 width | mm |
| Ultrasonic wave | | |
| generator | | |
| 1. Frequency | 19,000 | Hz |
| 2. Output | 600 | W |
| 3. Lubricant | Water | — |
| 4. Lubricant temp. | Room temp. | — |
| 5. Clearance | 0.5 | mm |
| 6. Horn diameter | 20 | mm |
| 7. Test time | 3 | min |

TABLE 3
Conditions for wearing test
(thrust-type wearing tester)

| Item | Dimension | Unit |
|---|---|---|
| Bearing | 27.2 in outer | mm |
| dimension | diameter × 22 in | |
| | inner diameter | |
| Test specific | 9.8 | MPa |
| load | | |
| Speed | 0.01 | mm/sec |
| Lubrication | SAE#30 | — |
| Surrounding | Room temp. | — |
| temp. | | |
| Time | 8 | Hrs |
| Shaft material | S55C | — |
| Hardness | 500 ˜ 600 | Hv10 |
| Roughness | 1 | Rmax. μm |

As is apparent from the foregoing Table 1, lubricating film layer 4 of test pieces of the present embodiment has a higher density and less voids than those of the conventional test pieces. Due to the higher density, the bond strength of lubricating film layer 4 toward half bearing 1 is higher and thus lubricating film layer 4 is less peelable. Cavitation-erosion test shows that erosion rate (exfoliation rate) is 0.4-1.0 in the case of test pieces of the present embodiment and is 1.1-2 in the case of conventional test pieces, and thus the test pieces of the present embodiment have a better cavitation resistance than the conventional test pieces. Wearing test also shows that the wearing rate is 1-12 μm in the case of the test pieces of the present embodiment and is 2-18 μm in the case of the conventional test pieces, and thus the test pieces of the present embodiment have a better wear resistance than the conventional test pieces.

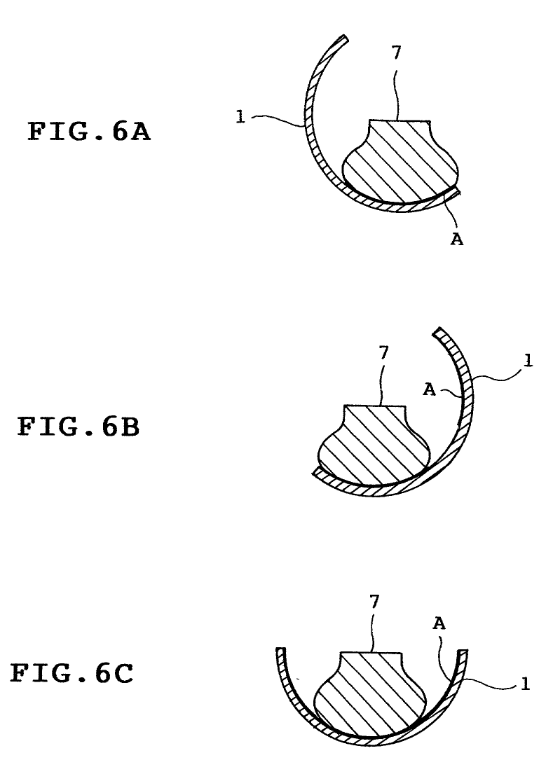

FIGS. 6A-6C show transfer modes according to a second embodiment, and a difference of the second embodiment from the first embodiment is that transfer of liquid dispersion A by pad 7 is carried out in a plurality of runs in a divided manner, for example, first run of transfer to one edge region in the circumferential direction on the inner surface of half bearing 1 as shown in FIG. 6A, a second run of transfer to the central region as shown in FIG. 6C, and a third run of transfer to other edge region in the circumferential direction as shown in FIG. 6B, 3 runs of transfer in total, thereby applying liquid dispersion A (lubricating film layer 4) to the entire inner surface of half bearing 1.

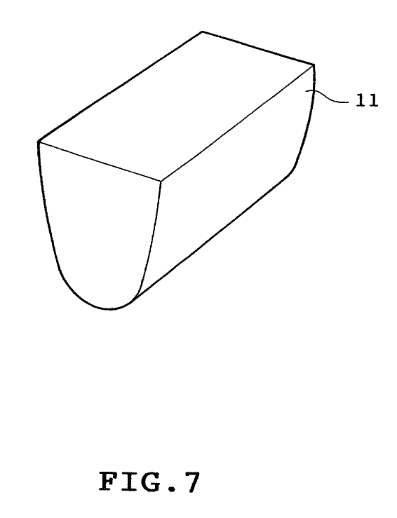

FIG. 7 shows a third embodiment of the present invention, and a difference of the third embodiment from the first and second embodiments is that pad 11 is in a semicylindrical shape with an arc-shaped surface downward the apex.

The present invention should not be limited only to the foregoing embodiments shown in the drawings, but can be changed or modified in the following manner.

After liquid dispersion A is applied to the inner surface of half bearing 1, followed by drying to form lubricating film layer 4, the lubricating film layer 4 is pressed by a mold or roll having the same circumferential profile as that of the inner surface of half bearing 1, thereby further increasing the density of lubricating film layer 4 and further improving the wear resistance, etc.

Sliding member to which liquid dispersion A is applied is not limited to bearings.

What is claimed is:

1. A process for forming an overlayer on a sliding member, which comprises applying a liquid dispersion containing a thermosetting resin and a solid lubricant to the surface of a sliding member by pad printing, thereby forming a lubricating film layer on the surface of the sliding member.

2. A process according to claim 1, wherein the application is carried out in a plurality of runs in a divided manner.

3. A process according to claim 1, wherein the sliding member is a half bearing.

4. A process according to claim 2, wherein the sliding member is a half bearing.

5. A process according to claim 3, wherein the pad is made from an elastically deformable material and has an arc-shaped surface or a spherical surface having a smaller outer diameter than the inner diameter of the half bearing at the part to be pressed to the inner surface of the half bearing.

6. A process according to claim 4, wherein the pad is made from an elastically deformable material and has an arc-shaped surface or a spherical surface having a smaller outer diameter than the inner diameter of the half bearing at the part to be pressed to the inner surface of the half bearing.
